(19) United States
(12) Patent Application Publication
(10) Pub. No.: US 2024/0385669 A1
(43) Pub. Date: Nov. 21, 2024

(54) GRACEFUL SHUTDOWN ON UNEXPECTED POWER SOURCE REMOVAL

(71) Applicant: Apple Inc., Cupertino, CA (US)

(72) Inventors: Vijayanish Varadharajan, Milpitas, CA (US); Madhavi V. Tagare, San Jose, CA (US); Mao Ye, San Jose, CA (US); Jikang Chen, Santa Clara, CA (US); Gregory G. Hurley, Scotts Valley, CA (US); Yezhou Wu, Shanghai (CN); Andrew James Lambert, Eagan, MN (US)

(21) Appl. No.: 18/351,858

(22) Filed: Jul. 13, 2023

(30) Foreign Application Priority Data
May 15, 2023 (CN) 202310543735.8

(51) Int. Cl. G06F 1/30; G06F 1/26; G06F 1/28

(52) U.S. Cl. CPC G06F 1/30; G06F 1/263; G06F 1/28

(57) ABSTRACT

An electronic device can include a plurality of subsystems; a primary power source; at least one backup energy storage; and a shutdown controller that detects unavailability of the primary power source. Upon detecting unavailability of the primary power source, the shutdown controller can cause one or more of the plurality of subsystems to reduce their power consumption; engage the at least one backup energy storage; initiate immediate power down of a first subset of the plurality of subsystems that does not result in data loss, data corruption, or physical system damage; and initiate sequenced power down of a second subset of the plurality of subsystems to prevent data loss or system damage, the second subset of the plurality of subsystems being powered by the at least one backup energy storage during the sequenced power down.

### BACKGROUND

Electronic devices may rely on power sources, such as batteries, that can become detached from the device or can otherwise become unavailable because of substantially complete discharge or other reasons. Electronic devices can also include one or more subsystems or modules that require certain shutdown procedures to prevent data loss or even damage to the device. In some cases, unexpected unavailability of a power source, because of disconnection or otherwise, can lead to data loss and even potentially damage to the device itself.

### SUMMARY

For such applications, it may be desirable to provide an electronic device and associated systems and methods that can allow the device to have a controlled, graceful shutdown upon unexpected disconnection or unavailability of the power source.

An electronic device can include a plurality of subsystems; a primary power source; at least one backup energy storage; and a shutdown controller that detects unavailability of the primary power source. Upon detecting unavailability of the primary power source, the shutdown controller can cause one or more of the plurality of subsystems to reduce their power consumption; engage the at least one backup energy storage; initiate immediate power down of a first subset of the plurality of subsystems that does not result in data loss, data corruption, or physical system damage; and initiate sequenced power down of a second subset of the plurality of subsystems to prevent data loss or system damage, the second subset of the plurality of subsystems being powered by the at least one backup energy storage during the sequenced power down.

One or more of the plurality of subsystems can be implemented as a power island, each power island comprising a power island subsystem, a power island backup energy storage, and a power island isolation device. The shutdown controller can further initiate isolation of the one or more power islands upon detecting unavailability of the primary power source. Isolation of the power island can allow controlled shutdown of the power island subsystem powered by the power island backup energy storage to prevent data loss or system damage wherein the power island backup energy storage does not power other subsystems.

The primary power source can be a disconnectable battery, and the shutdown controller can detect unavailability of the primary power source by detecting disconnection of one or more pins of a connector coupling the disconnectable battery to the electronic device. The shutdown controller can detect unavailability of the primary power source by detecting a decrease in voltage of a voltage bus powered by the primary power source. The shutdown controller can further engage a reverse current protection device that prevents energy flow from the backup energy storage to a connection point of the primary power source. The reverse current protection device can be a switch triggered by the shutdown controller. The reverse current protection device can be a solid state switch. The power island isolation device can be a switch triggered by the shutdown controller to disconnect the power island from a power bus of the electronic device. The power island isolation device can be a solid state switch.

The first subset of the plurality of subsystems can include a communication interface. The second subset of the plurality of subsystems can include a storage device, a sensor, or a display system.

A method of performing a graceful shutdown of an electronic device upon unavailability of a primary power source of the electronic device can include detecting unavailability of the primary power source; and upon detecting unavailability of the primary power source: causing one or more of the plurality of subsystems to reduce their power consumption; engaging at least one backup energy storage; initiating immediate power down of a first subset of the plurality of subsystems that will not result in data loss or system damage; and initiating sequenced power down of a second subset of the plurality of subsystems to prevent data loss or system damage, the second subset of the plurality of subsystems being powered by the at least one backup energy storage during the sequenced power down.

One or more of the plurality of subsystems can be implemented as a power island, each power island comprising a power island subsystem, a power island backup energy storage, and a power island isolation device. In such case the method further can further include initiating isolation of the one or more power islands upon detecting unavailability of the primary power source, wherein isolation of the power island allows controlled shutdown of the power island subsystem powered by the power island backup energy storage to prevent data loss or system damage.

The primary power source can be a disconnectable battery, and the shutdown controller can detect unavailability of the primary power source by detecting disconnection of one or more pins of a connector coupling the disconnectable battery to the electronic device. The shutdown controller can detect unavailability of the primary power source by detecting a decrease in voltage of a voltage bus powered by the primary power source. The method can further include engaging engages a reverse current protection device that prevents energy flow from the backup energy storage to a connection point of the primary power source.

The first subset of the plurality of subsystems can include a communication interface. The second subset of the plurality of subsystems includes a storage device, a sensor, or a display system.

### BRIEF DESCRIPTION OF THE DRAWINGS

FIG. 1 illustrates a block diagram of an electronic device.

FIG. 2 illustrates a process flow for graceful shutdown of an electronic device upon removal of a power source, such as a battery.

FIG. 3 illustrates a schematic/block diagram of an electronic device implementing graceful shutdown upon removal of a battery or other power source.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one.” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a drawing, refers to the same element throughout the several drawings, though it may not be repeated in every drawing. The drawings are not to scale unless otherwise indicated, and the proportions of certain parts may be exaggerated to better illustrate details and features of the present disclosure.

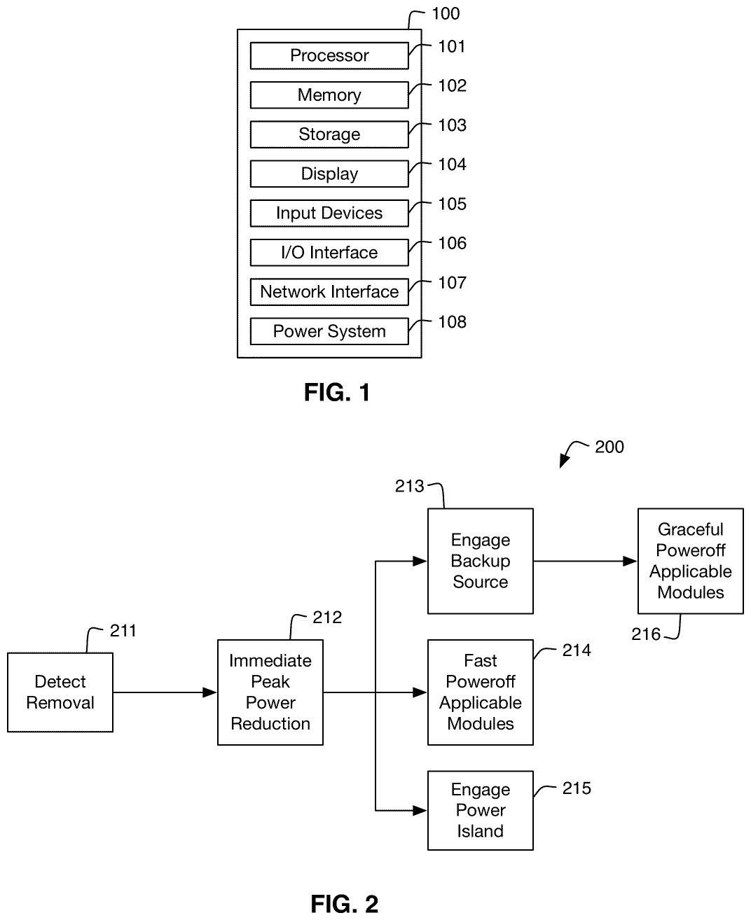

FIG. 1 is a block diagram of an electronic device 100, according to embodiments of the present disclosure. The electronic device 100 may include, among other things, one or more processors 101 (collectively referred to herein as a single processor for convenience, which may be implemented in any suitable form of processing circuitry), memory 102, nonvolatile storage 103, a display 104, input devices 105, an input/output (I/O) interface 106, a network interface 107, and a power system 108. The various functional blocks shown in FIG. 1 may include hardware elements (including circuitry), software elements (including machine-executable instructions), or a combination of both hardware and software elements (which may be referred to as logic). The processor 101, memory 102, the nonvolatile storage 103, the display 104, the input devices 105, the input/output (I/O) interface 106, the network interface 107, and/or the power system 108 may each be communicatively coupled directly or indirectly (e.g., through or via another component, a communication bus, a network, etc.) to one another to transmit and/or receive data amongst one another. It should be noted that FIG. 1 is merely one example of a particular implementation and is intended to illustrate the types of components that may be present in the electronic device 100.

By way of example, the electronic device 100 may include any suitable computing device, including a desktop or laptop/notebook computer (such as a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (such as an iPhone® available from Apple Inc. of Cupertino, California), a tablet computer (such as an iPad® available from Apple Inc. of Cupertino, California), a wearable electronic device (such as an Apple Watch® by Apple Inc. of Cupertino, California), and other similar devices.

Processor 101 and other related items in FIG. 1 may be embodied wholly hardware or by hardware programmed to execute suitable software instructions. Furthermore, the processor 101 and other related items in FIG. 1 may be a single contained processing module or may be incorporated wholly or partially within any of the other elements within the electronic device 100. Processor 101 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. Processor 101 may include one or more application processors, one or more baseband processors, or both, and perform the various functions described herein.

In the electronic device 100 of FIG. 1, processor 101 may be operably coupled with a memory 102 and a nonvolatile storage 103 to perform various algorithms. Such programs or instructions executed by processor 101 may be stored in any suitable article of manufacture that includes one or more tangible, computer-readable media. The tangible, computer-readable media may include the memory 102 and/or the nonvolatile storage 103, individually or collectively, to store the instructions or routines. The memory 102 and the nonvolatile storage 103 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by processor 101 to enable the electronic device 100 to provide various functionalities.

In certain embodiments, the display 104 may facilitate users to view images generated on the electronic device 100 In some embodiments, the display 104 may include a touch screen, which may facilitate user interaction with a user interface of the electronic device 100. Furthermore, it should be appreciated that, in some embodiments, the display 104 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input devices 105 of the electronic device 100 may enable a user to interact with the electronic device 100 (e.g., pressing a button to increase or decrease a volume level). The I/O interface 106 may enable electronic device 100 to interface with various other electronic devices, as may the network interface 107. In some embodiments, the I/O interface 106 may include an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 107 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, long term evolution (LTE®) cellular network, long term evolution license assisted access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 107 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 107 of the electronic device 100 may allow communication over the aforementioned networks (e.g., 5G, Wi-Fi, LTE-LAA, and so forth).

The network interface 107 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

The power system 108 of the electronic device 100 may include any suitable source of power, such as a rechargeable battery (e.g., a lithium ion or lithium polymer (Li-poly) battery) and/or a power converter, including a DC/DC power converter, an AC/DC power converter, a power adapter (which may be external), etc.

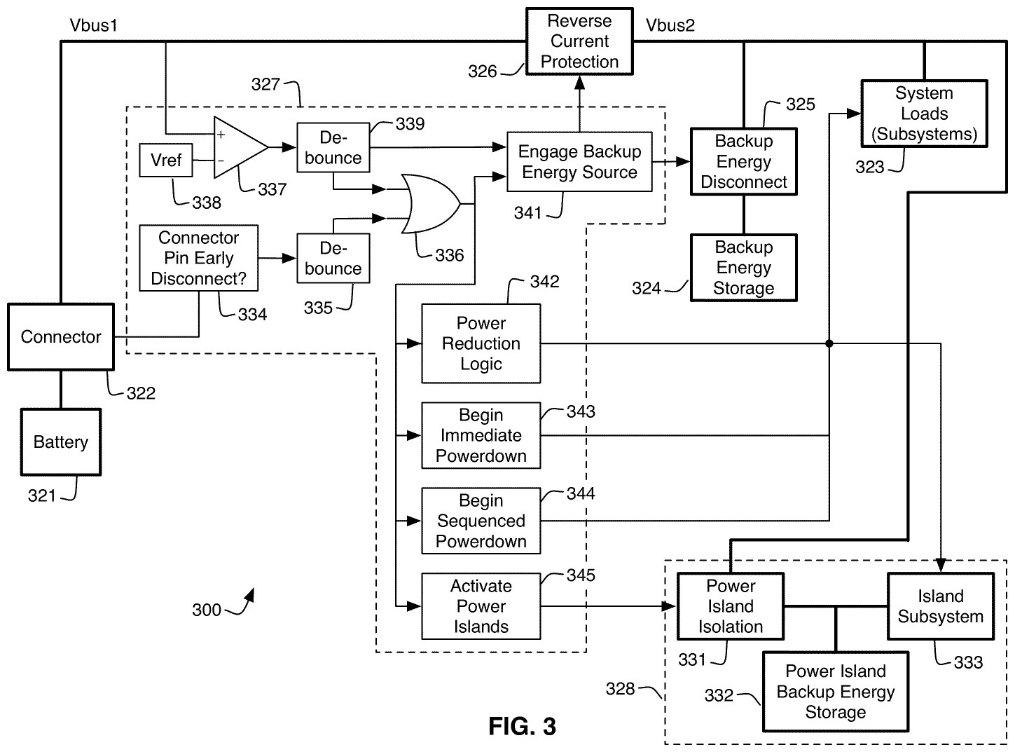

FIG. 2 illustrates a process flow 200 for shutdown of an electronic device (e.g., 100, FIG. 1; 300, FIG. 3) upon removal of a power source, such as a battery, in accordance with some embodiments. The process may be executed by one or more programmed processors operating alone and/or in combination with other suitable circuitry as described above with respect to FIG. 1 and below with respect to FIG. 3. For purposes of FIG. 2, such combinations of programmed processor(s) and/or other circuitry will be referred to as “the system.” In block 211, the system can detect that a power source, such as a battery, has been removed from the system. Although described in terms of removal of the battery, the process flow and system described herein can be employed in cases where other power sources are disconnected or removed (e.g., an AC mains adapter) and/or when the power source is not physically removed but rather becomes unavailable (e.g., because of discharge of an energy storage device such as a battery, capacitor, etc. As described in greater detail below with respect to FIG. 3, detection of battery (or power source) removal can be based on various techniques, including detection of disconnected connection pins, monitoring bus voltage, etc.

In any case, upon removal or unavailability of the power source, as detected in block 211, the system can begin an immediate peak power reduction as illustrated in block 212. This power reduction may vary for different modules of the system, but the general objective is to have the entire device transition as quickly as possible to a power consumption state that is as low as possible. Examples of such power reductions can include: reducing the clock speed and/or voltage supplied to processing, memory, or storage elements, reducing brightness of a display, reducing audio volume of an audio speaker, reducing the frequency of scanning input devices and/or the frequency of updating output devices, etc. In this stage of the process, the objective need not be to completely stop operation of any of the subsystems or modules of the device, but rather to immediately reduce power consumption of all subsystems/modules to extend the available “hold up” capacity for as long as possible. Thus, the immediate peak power reduction of block 212 can preferably occur very rapidly upon removal of the power source, e.g., on the order of microseconds.

After the immediate peak power reduction of block 212, the system can sequentially or preferably simultaneously perform one or more of three tasks identified in blocks 213, 214, and 215. Block 213 corresponds to engaging a backup energy source. Block 214 corresponds to performing a fast power off of all applicable modules. Block 215 corresponds to engaging power islands as appropriate. As noted above, these tasks are preferably performed simultaneously, i.e., in parallel, but could take place sequentially. If such tasks are performed sequentially, the order is not necessarily critical, although certain orders may be more desirable than others depending on the particulars of a given system. In any case, the timing of tasks corresponding to blocks 213, 214, and 215 can be on a somewhat longer time scale than the immediate peak power reduction of block 212, e.g., on the order of milliseconds.

In block 214, powering off applicable modules can include essentially interrupting or disconnecting the power supply to modules that can be immediately or quickly de-powered without the risk of damage to the subsystems and/or loss of data. As but one non-limiting example, it may be possible to immediately de-power a radio, such as a WiFi, Bluetooth®, cellular, or other data connection without the risk of subsystem damage and/or data loss. In some applications, this fast power off of applicable modules as illustrated in block 214 could be performed instead as part of the immediate peak power reduction of block 212.

In block 213, engaging a backup energy source can include various methods depending on the construction and requirements of the particular system. For example, engaging a backup power source could include switching a backup energy storage element, such as a capacitor, supercapacitor, backup battery, etc. into the circuit to provide further energy to supply power a holdup time period. This energy storage element can supply energy used in block 216 to perform a graceful power off of all applicable modules, i.e., those that require a graceful shutdown process that may take a relatively longer period of time (e.g., milliseconds) to complete. As but one non-limiting example, a flash storage device may require a particular shutdown sequence to ensure that all data has been written to appropriate cells and to prevent stopping the device in a state that will prevent further access to the data, either because of data corruption (i.e., storing data other than what was intended) or “damage” to the storage cells that prevents further access, which can be either physical damage or “logical” damage to the data structures that allow reading and writing to the storage device. As another example, some types of displays may be susceptible to physical damage to the display pixels if an appropriate shutdown sequence is not followed. As still another example, immediately de-powering a processor device could result in loss of user data, whereas a graceful shutdown process could allow for computation to stop at a suitable point allowing the data to be saved to storage before complete power loss. Various other subsystems/modules may need a graceful shutdown process to prevent damage (physical or logical) to the device and/or data loss or corruption, such as sensor modules, etc. Some modules or subsystems may also put themselves into a temporarily or permanently locked-down state upon unexpected power loss (i.e., the absence of a “clean” shutdown) as a defense against power glitching and similar attacks that might be used to access secure encrypted data, etc. In any case, all modules undergoing a graceful shutdown process may be configured to draw power from the engaged common backup energy source (block 213) to perform the graceful power off (block 216).

In block 215, the system can engage one or more “power islands” to allow certain modules or sub-systems to gracefully power down from their own backup energy storage. Power islands are described in greater detail below with reference to FIG. 3, but, in general, engaging a power island can include disconnecting a particular sub-system or module from the main power bus of the device. Such a sub-system or power module can have its own backup energy storage that can allow it to perform a graceful shutdown of the subsystem using its own backup energy that is not shared with other modules or subsystems. Such power islands may be advantageous for subsystems that have relatively high clean shutdown energy requirements and/or that take a relatively long time to perform a graceful shutdown. By effectively isolating the backup energy storage for such elements, the total backup energy storage for the system as a whole (i.e., the entire electronic device) may be reduced because it need not be sized to account for the possibility of other loads drawing from it while the longer shutdown periods of certain modules or sub-systems takes place. Additionally, by being isolated to their own power islands, certain modules or subsystems with relatively longer graceful shutdown periods and/or relatively higher shutdown power requirements can be guaranteed to have sufficient energy available without worry of their shutdown power being consumed by another module or sub-system.

FIG. 3 illustrates a schematic/block diagram of an electronic device 300 implementing graceful shutdown upon removal of a battery or other power source as described above with respect to FIG. 2. The power topology of electronic device 300 can be as follows: Electronic device 300 may be powered by a battery 321, which may be a removable battery. Battery 321 may connect to the system via a connector 322 that couples battery 321 to a main voltage bus Vbus1 of the electronic device. Although the power source for device 300 is illustrated as being a battery 321, the teachings herein are also applicable to other power sources, such as an AC mains adapter, etc. Main voltage bus Vbus1 may be segmented to a further main voltage Vbus2 by a reverse current protection device 326, discussed in greater detail below. Main voltage bus Vbus2 may be coupled to one or more system loads (subsystems) 323 corresponding to various modules or subsystems of the electronic device, e.g., modules 101-107 discussed above. A backup energy storage source 324 can also be coupled to main voltage bus Vbus2 by a backup energy disconnect device 325, discussed in greater detail below. Also, one or more power island modules 328 or subsystems 323 can be coupled to the main voltage bus Vbus2, as described in greater detail below.

The power control topology of electronic device 300 can be as follows: A shutdown controller 327 can monitor the power source (e.g., battery 321) and/or main voltage bus Vbus1 to determine whether the power source has been removed and/or is no longer available. Upon detecting the removal or unavailability of the power source, shutdown controller 327 can initiate and control a graceful shutdown process as described above with respect to FIG. 2 and in more detail below. Shutdown controller 327 can be its own controller, implemented using a programmable controller, ASIC, FPGA, etc. Alternatively, shutdown controller 327 could be implemented as part of another system or subsystem such as a power management integrated circuit (PMIC) or one or more other processing systems of electronic device 300.

In any case, shutdown controller can detect removal of the power source (e.g., battery 321) in various ways. For example, controller 327 can include connector pin early disconnect logic 334 that monitors connector 322 to detect removal of the power source, e.g., by monitoring one or more pins of connector 322 to detect disconnection. In some cases, this may give more advanced notice of power source removal than voltage bus monitoring, allowing controller 327 to more quickly begin the graceful shutdown process. For example, upon detecting disconnection, the signal can be passed to OR gate 336 (which although illustrated as a physical device may be implemented in a programmable or otherwise configurable logic using hardware and/or software), the output of which passes to the various shutdown logic blocks 341-345 discussed in greater detail below. In some embodiments, the signal between the connector pin early disconnect logic 334 and OR gate 336 may be subject through debounce circuitry 335 to prevent false detections. Additionally, or alternatively, controller 327 can detect removal or unavailability of the power source by monitoring the main voltage bus Vbus1. For example, the main bus voltage can be compared to a voltage reference Vref (338) by comparator 337. Although illustrated as a physical device, comparator 337 may also be implemented in programmable or otherwise configurable logic using hardware and/or software. The result of this comparison can be passed to another input of OR gate 336. In some embodiments, the output of comparator 337 may be subject through debounce circuitry 339 to prevent false detections. The output of comparator 337 can also be passed directly to the engage backup energy source logic 341 as described in greater detail below.

The output signal of OR gate 336 is thus indicative of removal or unavailability of the power source (e.g., battery 321) for electronic device 300. This output signal can be provided to engage backup energy source block 341. This block may be implemented using any appropriate combination of analog/digital, discrete/integrated, and/or programmable circuitry. Engage backup energy source block 341 can provide a signal to backup energy disconnect 325 to allow backup energy storage 324 to be connected to supply energy to main voltage bus Vbus2 to allow backup energy storage 324 to power the system loads/subsystems 323 and (temporarily) power islands 328. Backup energy storage 324 can take various forms depending on the requirements of electronic device 300. For example, backup energy storage 324 can be a capacitor, supercapacitor, backup battery, etc.

Depending on the implementation of backup energy storage 324, backup energy disconnect 325 may also take a variety of forms. In the simplest case, backup energy disconnect 325 can be a switch, implemented either mechanically or preferably as a solid state device, such as back-to-back MOSFETs (metal oxide semiconductor field effect transistors) or other suitable solid state switching devices. In other cases, backup energy disconnect may be more sophisticated. As one example, when powering up the system from the normal power source (e.g., battery 321) it may be desirable to limit inrush current associated with initially charging backup energy storage 324. Thus, the solid state switch(es) making up backup energy disconnect 325 may be operated in their active region to provide current limiting. Additionally or alternatively, backup energy disconnect could include a more complex topology that selectively couples other current limiting or controlling elements into the circuit to regulate initial charging of backup energy storage 324. In still other cases, backup energy disconnect 325 may be even more complex and/or include more sophisticated functionality. For example, if backup energy storage 324 is a backup battery, backup energy disconnect could be implemented as a bidirectional buck/boost converter that allows controlled charging of backup energy storage 324 when the main power source (e.g., battery 321) is available and delivers power to main voltage bus Vbus2 when it is not.

In addition to selectively coupling backup energy storage 324 to the main voltage bus Vbus2 upon disconnection or unavailability of electronic device 300's normal power source (e.g., battery 321), the engage backup energy source block 341 may also activate reverse current protection device 326. The purpose of reverse current protection device 326 can be to prevent energy from backup energy storage 324 from flowing back to the power input and unnecessarily depleting the stored energy. In the simplest case, backup energy disconnect 325 can be a switch, implemented either mechanically or preferably as a solid state device, such as back-to-back MOSFETs or other suitable solid state switching devices.

The output signal of OR gate 336 (indicative of removal or unavailability of the power source, e.g., battery 321, for electronic device 300) can also be provided to power reduction logic block 342. This block may be implemented using any appropriate combination of analog/digital, discrete/integrated, and/or programmable circuitry. Power reduction logic block 342 can correspond to block 212 of process 200 described above with respect to FIG. 2. As described above power reduction logic block 342 can begin an immediate peak power reduction, which may vary for different modules of the system. The general objective is to have the entire device transition as quickly as possible to a power consumption state that is as low as possible. Examples of such power reductions can include various combination of reducing the clock speed and/or voltage supplied to various systems to reduce power consumption, reducing display brightness, reducing audio volume, reducing input device scanning frequencies and/or output device update frequencies, etc. In this stage of the process, the objective need not be to completely stop operation of any of the subsystems or modules of the device, but rather to immediately reduce power consumption of all subsystems/modules to extend the available “hold up” capacity for as long as possible. Thus, the immediate peak power reduction can preferably occur very rapidly upon removal of the power source, e.g., on the order of microseconds. To that end, the output of power reduction logic block 342 can be coupled to applicable subsystems, as represented by system loads (subsystems 323) and island subsystem(s) 333 to communicate the desired/required power reductions to such systems.

The output signal of OR gate 336 (indicative of removal or unavailability of the power source, e.g., battery 321, for electronic device 300) can also be provided to begin immediate powerdown block 343. This block may be implemented using any appropriate combination of analog/digital, discrete/integrated, and/or programmable circuitry. Begin immediate powerdown block 343 can correspond to block 214 of process 200 described above with respect to FIG. 2. Immediately powering off applicable modules can include essentially interrupting or disconnecting the power supply to modules that can be immediately or quickly de-powered without the risk of damage to the subsystems and/or loss of data. As but one non-limiting example, it may be possible to immediately de-power a radio, such as a WiFi, Bluetooth®, cellular, or other data connection without the risk of subsystem damage and/or data corruption. To that end, the output of begin immediate powerdown block 343 can be coupled to applicable subsystems, as represented by system loads (subsystems 323) and island subsystem(s) 333 to communicate the desired/required shutdowns to such systems. In some cases, rather than communicating to instruct an immediate powerdown to these sub-systems, the outputs of begin immediate powerdown block 343 could be used to disconnect power to applicable subsystems, e.g., by triggering a disconnect device (not shown) decoupling such subsystems or modules from main voltage bus Vbus2. In some applications, this fast power off of applicable modules could be performed instead by power reduction logic block 342.

The output signal of OR gate 336 (indicative of removal or unavailability of the power source, e.g., battery 321, for electronic device 300) can also be provided to begin sequenced powerdown block 344. This block may be implemented using any appropriate combination of analog/digital, discrete/integrated, and/or programmable circuitry. Begin sequenced powerdown block 344 can correspond to block 216 of process 200 described above with respect to FIG. 2. As described above, backup energy storage 324 can supply energy required to perform an orderly shutdown power off of all applicable modules, i.e., those that require a graceful shutdown process that may take a relatively longer period of time (e.g., milliseconds) to complete. As but one non-limiting example, a flash storage device may require a particular shutdown sequence to ensure that all data has been fully stored in the appropriate cells and to prevent stopping the device in a state that will damage or prevent further access to the device. As another example, immediately de-powering a processor device could result in loss of user data, whereas a graceful shutdown process could allow for computation to stop at a suitable point allowing the data to be saved to storage before complete power loss. Various other subsystems/modules may need a graceful shutdown process to prevent damage to the device and/or data loss, such as sensor modules, display modules, etc. In any case, all modules undergoing a graceful shutdown process may be configured to draw power from the engaged backup energy storage 324 to perform the graceful power off (block 216). To that end, the output of begin sequenced powerdown block 344 can be coupled to applicable subsystems, as represented by system loads (subsystems 323) to communicate the desired/required shutdowns to such systems.

The output signal of OR gate 336 (indicative of removal or unavailability of the power source, e.g., battery 321, for electronic device 330) can also be provided to activate power islands block 345. This block may be implemented using any appropriate combination of analog/digital, discrete/integrated, and/or programmable circuitry. Activate power islands block 345 can correspond to block 215 of process 200 described above with respect to FIG. 2. As described above, the system can engage one or more power islands 328 to allow certain modules or sub-systems to gracefully power down from their own backup energy storage. Each power island 328 can include the island subsystem, i.e., the modules or sub-system that the power island powers, which can be one of the various functional blocks 101-107 discussed above with respect to FIG. 1. Each power island 328 can also include power island backup energy storage 332 that can serve as the energy source for orderly shutdown of the island subsystem 333. Like backup energy storage 324, power island backup energy storage 332 can take a variety of forms depending on the requirements of the power island system. Such forms can include capacitors, supercapacitors, backup batteries, or other suitable energy storage devices. Each power island 328 can also include a power island isolation device 331. Like backup energy disconnect 325, power island isolation device 331 can take a variety of forms depending on the implementation of power island backup energy storage 332. These forms can range from relatively simple mechanical or solid state switches to more complex arrangements allowing for current limiting, voltage conversion, or other required functionalities.

In any case, engaging a power island can include disconnecting that power island, and thus a particular sub-system or module, from the main power bus of the device by selective operation of power island isolation device 331. Because each power island can have its own backup energy storage that can allow it to perform a graceful shutdown of the subsystem using its own backup energy that is not shared with other modules or subsystems. Such power islands may be advantageous for subsystems that have relatively high orderly shutdown energy requirements and/or that take a relatively long time to perform a graceful shutdown. By effectively isolating the backup energy storage for such elements, the total backup energy storage for the system as a whole (i.e., the entire electronic device) may be reduced because it need not be sized to account for the possibility of other loads drawing from it while the longer shutdown periods of certain modules or sub-systems takes place. Additionally, by being isolated to their own power islands, certain modules or subsystems with relatively longer graceful shutdown periods and/or relatively higher shutdown power requirements can be guaranteed to have sufficient energy available without worry of their shutdown power being consumed by another module or sub-system. To that end, the output of activate power islands block 345 can be coupled to applicable subsystems, as represented by power island(s) 328 and power island isolation device(s) 331 to initiate the isolation of the respective power island(s).

The foregoing describes exemplary embodiments of systems and methods for providing graceful shutdown of an electronic device upon removal or other unavailability of a main power source for such electronic device. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. An electronic device comprising:
a plurality of subsystems;
a primary power source;
at least one backup energy storage; and
a shutdown controller that detects unavailability of the primary power source and upon detecting unavailability of the primary power source:
causes one or more of the plurality of subsystems to reduce their power consumption;
engages the at least one backup energy storage;
initiates immediate power down of a first subset of the plurality of subsystems that does not result in data loss, data corruption, or physical system damage; and
initiates sequenced power down of a second subset of the plurality of subsystems to prevent data loss or system damage, the second subset of the plurality of subsystems being powered by the at least one backup energy storage during the sequenced power down.

2. The electronic device of claim 1:
wherein one or more of the plurality of subsystems are implemented as a power island, each power island comprising a power island subsystem, a power island backup energy storage, and a power island isolation device; and
wherein the shutdown controller further initiates isolation of the one or more power islands upon detecting unavailability of the primary power source, wherein isolation of the power island allows controlled shutdown of the power island subsystem powered by the power island backup energy storage to prevent data loss or system damage wherein the power island backup energy storage does not power other subsystems.

3. The electronic device of claim 2 wherein the primary power source is a disconnectable battery and the shutdown controller detects unavailability of the primary power source by detecting disconnection of one or more pins of a connector coupling the disconnectable battery to the electronic device.

4. The electronic device of claim 2 wherein the shutdown controller detects unavailability of the primary power source by detecting a decrease in voltage of a voltage bus powered by the primary power source.

5. The electronic device of claim 2 wherein the shutdown controller further engages a reverse current protection device that prevents energy flow from the backup energy storage to a connection point of the primary power source.

6. The electronic device of claim 5 wherein the reverse current protection device is a switch triggered by the shutdown controller.

7. The electronic device of claim 6 wherein the reverse current protection device is a solid state switch.

8. The electronic device of claim 2 wherein the power island isolation device is a switch triggered by the shutdown controller to disconnect the power island from a power bus of the electronic device.

9. The electronic device of claim 8 wherein the power island isolation device is a solid state switch.

10. The electronic device of claim 2 wherein the first subset of the plurality of subsystems include a communication interface.

11. The electronic device of claim 2 wherein the second subset of the plurality of subsystems includes a storage device, a sensor, or a display system.

12. The electronic device of claim 1 wherein the primary power source is a disconnectable battery and the shutdown controller detects unavailability of the primary power source by detecting disconnection of one or more pins of a connector coupling the disconnectable battery to the electronic device.

13. The electronic device of claim 1 wherein the shutdown controller detects unavailability of the primary power source by detecting a decrease in voltage of a voltage bus powered by the primary power source.

14. The electronic device of claim 1 wherein the shutdown controller further engages a reverse current protection device that prevents energy flow from the backup energy storage to a connection point of the primary power source.

15. The electronic device of claim 1 wherein the first subset of the plurality of subsystems include a communication interface.

16. The electronic device of claim 1 wherein the second subset of the plurality of subsystems includes a storage device, a sensor, or a display system.

17. A method of performing a graceful shutdown of an electronic device upon unavailability of a primary power source of the electronic device, the electronic device having a plurality of subsystems, the method being performed by a controller of the electronic device and comprising:
detecting unavailability of the primary power source; and
upon detecting unavailability of the primary power source:
causing one or more of the plurality of subsystems to reduce their power consumption;
engaging at least one backup energy storage;
initiating immediate power down of a first subset of the plurality of subsystems that will not result in data loss or system damage; and
initiates sequenced power down of a second subset of the plurality of subsystems to prevent data loss or system damage, the second subset of the plurality of subsystems being powered by the at least one backup energy storage during the sequenced power down.

18. The method of claim 17 wherein one or more of the plurality of subsystems are implemented as a power island, each power island comprising a power island subsystem, a power island backup energy storage, and a power island isolation device, the method further comprising:
initiating isolation of the one or more power islands upon detecting unavailability of the primary power source, wherein isolation of the power island allows controlled shutdown of the power island subsystem powered by the power island backup energy storage to prevent data loss or system damage.

19. The method of claim 18 wherein the primary power source is a disconnectable battery and the shutdown controller detects unavailability of the primary power source by detecting disconnection of one or more pins of a connector coupling the disconnectable battery to the electronic device.

20. The method of claim 18 wherein the shutdown controller detects unavailability of the primary power source by detecting a decrease in voltage of a voltage bus powered by the primary power source.

21. The method of claim 18 further comprising engaging engages a reverse current protection device that prevents energy flow from the backup energy storage to a connection point of the primary power source.

22. The method of claim 18 wherein the first subset of the plurality of subsystems include a communication interface.

23. The method of claim 18 wherein the second subset of the plurality of subsystems includes a storage device, a sensor, or a display system.

24. The method of claim 17 wherein the primary power source is a disconnectable battery and the shutdown controller detects unavailability of the primary power source by detecting disconnection of one or more pins of a connector coupling the disconnectable battery to the electronic device.

25. The method of claim 17 wherein the shutdown controller detects unavailability of the primary power source by detecting a decrease in voltage of a voltage bus powered by the primary power source.

26. The method of claim 17 further comprising engaging engages a reverse current protection device that prevents energy flow from the backup energy storage to a connection point of the primary power source.

27. The method of claim 17 wherein the first subset of the plurality of subsystems include a communication interface.

28. The method of claim 17 wherein the second subset of the plurality of subsystems includes a storage device, a sensor, or a display system.
